(19) United States
(12) Patent Application Publication
(10) Pub. No.: US 2010/0265100 A1
(43) Pub. Date: Oct. 21, 2010

(54) SYSTEMS AND METHODS FOR INTELLIGENT LIGHTING

(75) Inventors: Bassam D. Jalbout, Quebec (CA); Brian Wong, Kirkland (CA)

Correspondence Address: McDermott Will & Emery, 600 13th Street, NW, Washington, DC, 20005-3096, US

(73) Assignee: LSI INDUSTRIES, INC., Cincinnati, OH (US)

(21) Appl. No.: 12/426,468

(22) Filed: Apr. 20, 2009

(51) Int. Cl. G08G 1/14; G08G 1/01

(52) U.S. Cl. 340/932.2; 340/933; 340/944

(57) ABSTRACT

Systems and methods are disclosed for the intelligent lighting of large areas and structures such as parking garages. Ultrasonic distance measuring sensors can be used to obtain occupancy data for the area or structure, such as a parking garage, and to control the intensities of the individual lights in the system for energy conservation. Persons in the area, e.g. parking their cars, can be shown the path to the exit by specific preset intensity level and/or color of light. In parking garage embodiments, persons in the process of parking their cars are shown the empty spots by lights of a specific intensity and/or color. The addition of passive infrared motion detectors enables the system to illuminate the area around a moving person, and alarm if a person is behaving unexpectedly. A controller can communicate with sensors and/or lighting elements by wireless or wire (cable) communication.

### BACKGROUND

Conventional lighting in a open spaces such as parking garages is typically accomplished by overhead lights that are simply turned on and left on for a designated time. Such light is extremely inefficient, both in the use of energy, and in human interaction. Typically, the lights are at full intensity at all times.

This means that empty spaces, with no people present, such as empty parking spaces and empty cars themselves are illuminated at full intensity for no reason, resulting in a great waste of energy.

For such constantly lit open spaces, people may not be able to discern available spaces due to the large distances involved or indirect lines of sight. In today's fast-paced and highly competitive environment, it is imperative for parking facility owners to ensure a seamless and enjoyable experience for each visitor. For example, in large cities such as New York, Chicago, San Francisco, Beijing, Shanghai, Tokyo, Seoul, London, Paris, Rome, and Berlin, it is becoming increasingly difficult to find available parking. Even when available parking spaces exist, visitors often have to circle around to find them. This leads to a waste of the visitors' time, increased pollution, increased use of fuel, and increased visitor stress and frustration. In commercial areas, increased time in the parking lot reduces the time consumers are in the stores or mall, which reduces their revenues.

What is needed therefore are new techniques that provide for improved, effective, and energy-efficient lighting for parking garages.

### SUMMARY

The present disclosure is directed to novel techniques, including systems and methods, addressing and remedying the limitations noted previously.

Aspects and embodiments of the present disclosure provide intelligent lighting for spaces/structures such as parking garages, warehouses, and the like. By using different intensity levels for different conditions in the area near each light, there is a great potential for saving energy, as well as indicating the availability of empty spaces, or lighting and indicating the pathway to and from the exits, for the users.

An aspect of the present disclosure is directed to intelligent lighting systems that improve on the performance of conventional lighting systems.

An embodiment of an intelligent lighting system can include a set or array of lights, each of which is capable of producing several levels of intensity and possibly colors, as well as flashing on and off. A lighting system computer coordinates the intensity and color of each of the set of lights. The use of a lower intensity allows energy savings, while retaining higher intensities only when required for persons or cars using the garage areas, and only in the areas actually in immediate use.

A further aspect of the present disclosure is directed to methods of intelligent lighting for large spaces such as parking garages.

An embodiment of a method of lighting a parking garage can include (i) illuminating a plurality of more parking stalls in a parking garage with a plurality of lighting elements, (ii) obtaining occupancy data of the parking stalls by using a plurality of ultrasonic distance measuring sensors, and (iii) using the occupancy data for control of the light intensities and/or color of the individual lighting elements.

One skilled in the art will appreciate that embodiments and/or portions of embodiments of the present disclosure can be implemented in/with computer-readable storage media (e.g., hardware, software, firmware, or any combinations of such), and can be distributed over one or more networks. Steps described herein, including processing functions to derive, learn, or calculate formula and/or mathematical models utilized and/or produced by the embodiments of the present disclosure, can be processed by one or more suitable processors, e.g., central processing units (“CPUs) implementing suitable code/instructions in any suitable language (machine dependent or machine independent).

While aspects of the present disclosure are described herein in connection with certain embodiments, it is noted that variations can be made by one with skill in the applicable arts within the spirit of the present disclosure and the scope of the appended claims.

### BRIEF DESCRIPTION OF DRAWINGS

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 depicts a layout of one light in an intelligent lighting system, in accordance with an embodiment of the present disclosure;

FIG. 2 depicts an ultrasonic distance sensor used to detect the presence of an automobile in any particular stall/parking space, in accordance with an embodiment of the present disclosure;

FIG. 3 depicts a diagrammatic view of an intelligent lighting system, in accordance with exemplary embodiments of the present disclosure;

FIG. 4 depicts the intelligent lighting system of FIG. 3 indicating a pedestrian pathway by using different lighting intensities;

FIG. 5 depicts the intelligent lighting system of FIG. 3 illuminating the way for a pedestrian on the way to an automobile;

FIG. 6 depicts the intelligent lighting system of FIG. 3 indicating available parking spots by using a particular intensity/color, in accordance with an embodiment of the present disclosure;

FIG. 7 depicts a priority status byte for a module of an intelligent lighting system, in accordance with exemplary embodiment of the present disclosure;

FIG. 8 depicts a logic flowchart for an overall intelligent lighting system, in accordance with an embodiment of the present disclosure;

FIG. 9 depicts a logic flowcharts reactions of an intelligent lighting system for various pedestrian scenarios, in accordance with an embodiment of the present disclosure;

FIG. 10 depicts logic flowcharts for reactions of an intelligent lighting system for various automobile entry and exit scenarios, in accordance with an embodiment of the present disclosure;

FIG. 11 depicts a logic flowchart for internal housekeeping activities of an intelligent lighting system, in accordance with an embodiment of the present disclosure;

FIG. 12 depicts a system interconnection scheme for data and power, in accordance with an embodiment of the present disclosure;

FIG. 13 depicts the data and power connections at the individual lights of a representative system portion, in accordance with an embodiment of the present disclosure;

FIG. 14 depicts a system in which multiple acoustic sensors are located in a single housing, in accordance with an embodiment of the present disclosure; and

FIG. 15 depicts how the multiple acoustic sensors in the same housing are each set to monitor different parking spots in accordance with an embodiment of the present disclosure.

While certain embodiments depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION

Aspects of the present disclosure are, in general terms, directed to systems and methods providing for intelligent lighting for large areas such as a parking garages. Conventional lighting, e.g., for parking garages and the like, often wastes light by unnecessarily illuminating unused areas, usually at high intensity. Intelligent lighting techniques of the present disclosure (e.g., for parking garages) are energy efficient, by lighting with high intensity only those areas where there is immediate activity, e.g., either by cars or pedestrians. Other areas are left at a low energy or are turned completely off, saving electricity. Intelligent lighting techniques can also provides additional features, by lighting the pathway to the nearest exit or available parking spot. An extra level of safety, can be provided by indicating the presence of persons loitering in the area (e.g., garage) or moving in a suspicious pattern.

Embodiments can include a system with a set of individual lights, each of which is operational to change intensity and/or color, as determined by a controller or means, which can include/run an optimizing algorithm in a suitable language in a computer-readable storage medium. The lighting system can sense the status and conditions in the individual parking stalls (or subareas) nearby by use of ultrasonic distance measuring units above each space/stall. The data indicating the status of each space/stall is used by the lighting system computer to coordinate the entire set of lights to optimize the intensity state of each light in the set. Where required, motion sensors are used to detect the presence of pedestrians. The optimizing algorithm allows the lights to be dimmed or turned off completely when the immediate surrounding area has no pedestrians and no car activity. The entrance of a car to be parked in the area causes the lights with empty or available stalls to signal with a high intensity, or a blinking signal. The parking of a car causes the pedestrian path to the exit to be specifically illuminated. The presence of a pedestrian in an area causes the lights in that area to go to a high intensity. The detection of a car leaving a parking stall causes the lights leading towards the exit to become brighter or otherwise signal the path. The presence of a pedestrian loitering, or moving in an unorthodox pattern causes the lights in that area to flash in an alarm condition.

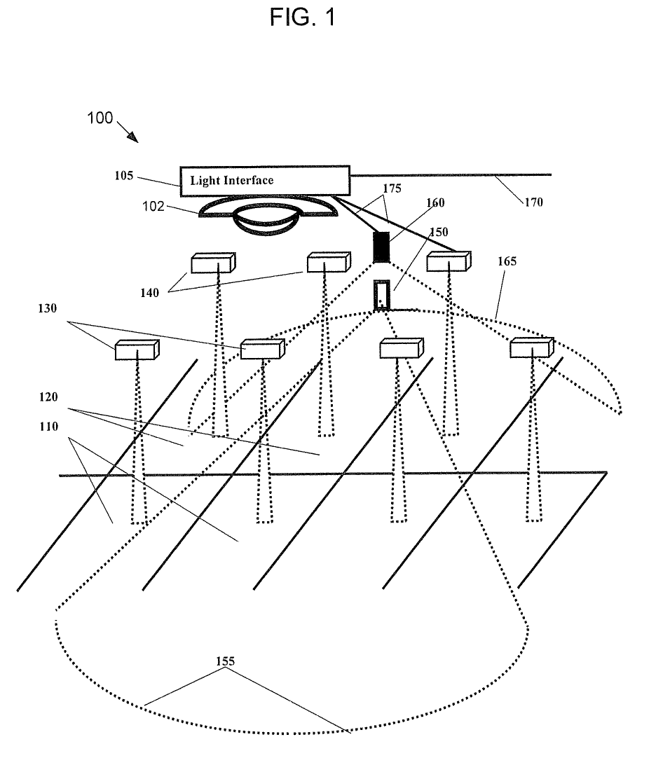

FIG. 1 depicts a diagrammatic view of a portion of an intelligent lighting system 100 according to an embodiment of the present disclosure. System 100 includes a number of lights, which can be any desired type, including but not limited to metal halide lamps, light-emitting diodes (“LEDs”), incandescent lights, fluorescent lights, etc. Light 102 is shown augmented by ultrasonic distance detectors 130, 140. For the embodiment shown, ultrasonic distance detectors 130 monitor parking stalls 110, and ultrasonic distance detectors 140 which monitor the parking stalls 120 in the adjacent row. These ultrasonic distance detectors can detect the presence or absence of a car in their assigned parking stall, as will be shown later. Light 102 covers all of the parking stalls 110 and 120. Additionally, passive infrared motion detectors 150 and 160 can be present to monitor the area for the presence of people 155 and 165. The system 100 can provide lighting of a desired lamination, e.g., when one or more persons are in an area, the system can illuminate the area in accordance with the Illuminating Engineering Society of North America (“IESNA”) specification RP-20-98 for the “basic” recommended maintained illuminance (light intensity) values for parking garage lighting with a maximum to minimum illuminance ratio not greater than 10 to 1, with a minimum requirement of 1 footcandle (“fc”; one footcandle is approximately equal to 10.764 lux) everywhere on a target area and a minimum vertical illuminance of 0.5 fc 5 feet above ground.

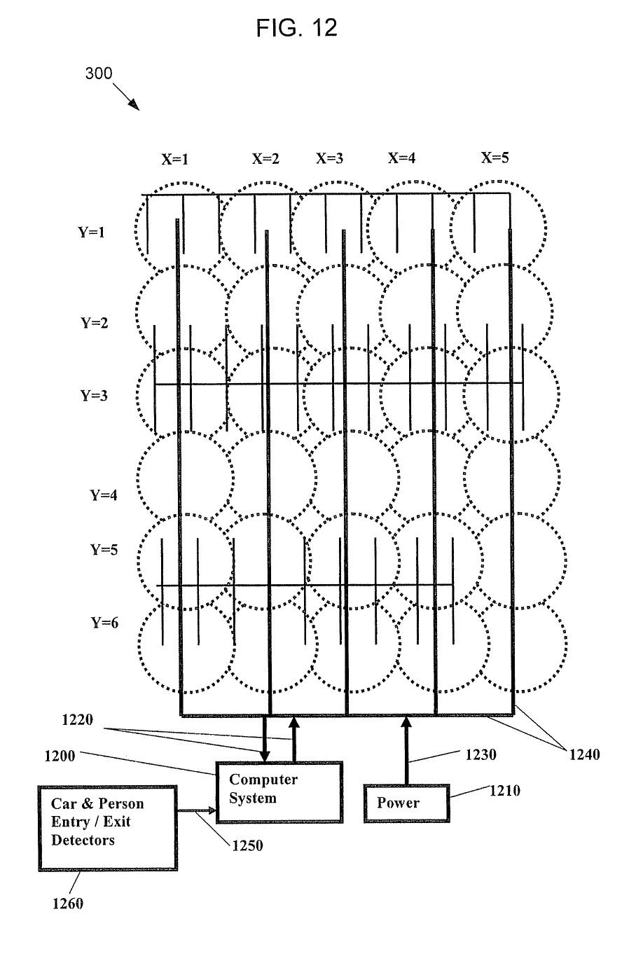

Continuing with the description of FIG. 1, the interface unit of the light, 105, connects with cables 175 to the ultrasonic detectors 140, 150 and passive infrared motion detectors 150, 160 to provide them with power and also to collect the results of their sensing functions. A cable system, 170, providing power and a data link, for this intelligent light unit, and also interconnects each unit to the entire system. This interconnection, as shown later, provides control and monitoring of the intelligent lighting system from a central computerized system, 1200. When the ultrasonic distance detectors 130, 140, or the passive infrared motion detectors 150, 160, detect significant activity by automobile or pedestrian, the activity is reported via the lighting unit 102, 105, which takes the appropriate response, i.e. set the correct intensity and color level, and correlates this response with other lights in the intelligent lighting system by data communication through link 170 to a central computer, 1200 of FIG. 12. The central computer coordinates the data from each intelligent light module, type 102, to provide a logically derived system lighting response, for the parking garage overall, based on all the incoming data.

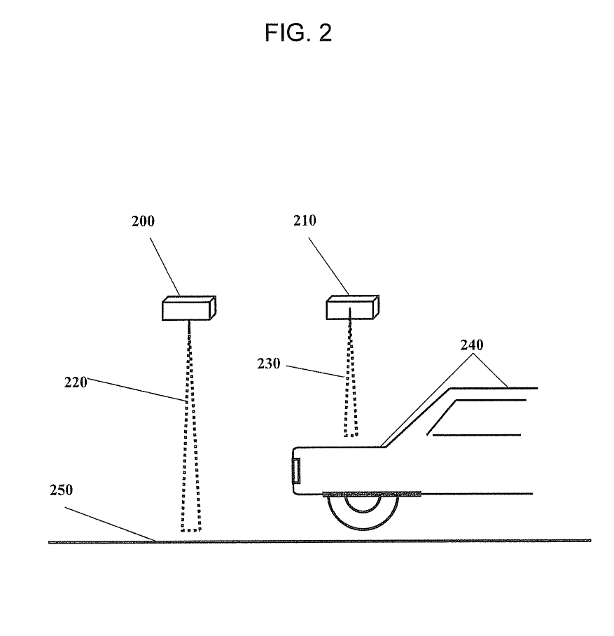

FIG. 2 depicts a diagrammatic view of ultrasonic distance sensors as used to detect the presence of an automobile in any particular stall/parking space, in accordance with an embodiment of the present disclosure. FIG. 2 shows how an ultrasonic distance measuring unit, commercially available, e.g., Maxsonar—EZ1, can be used to detect whether a parking stall is occupied or vacant. Ultrasonic distance measuring unit 200 is mounted over a currently unoccupied parking stall, and measures the distance to the ground, 250. Ultrasonic distance measuring unit 210 is mounted over a parking stall which is currently occupied by automobile 240, and measures the distance to said automobile, 230. The difference between an occupied and occupied parking stall is very easily distinguishable to the ultrasonic distance measuring unit, which reports the parking stall status to its assigned intelligent light unit.

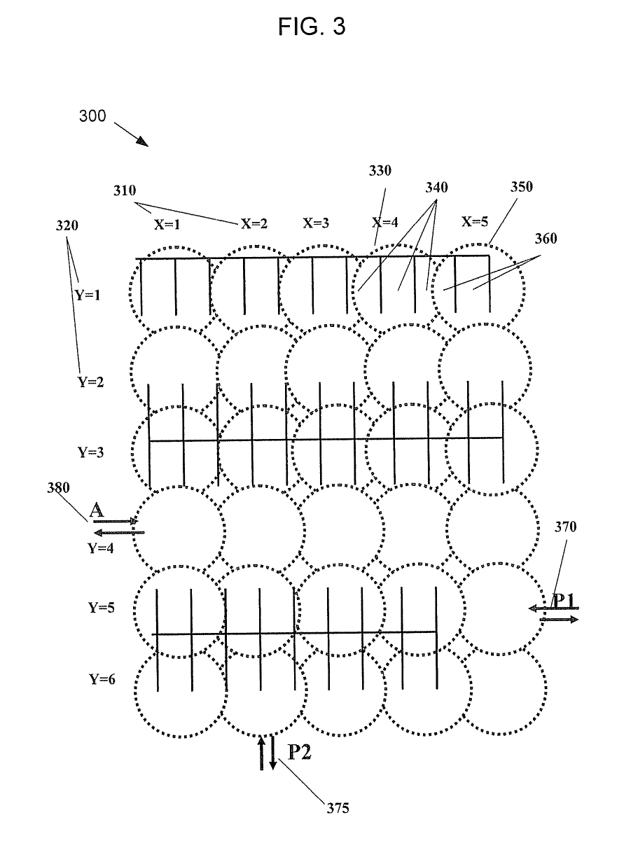

FIG. 3 depicts a diagrammatic plan view of lighting areas of an intelligent lighting system 300 for a parking garage, in accordance with exemplary embodiments of the present disclosure. Automobile access is denoted by A 300 and adjacent arrows while pedestrian accessible routes are denoted by P1 370 and P2 375 and adjacent arrows. FIG. 3 indicates illumination provided by the intelligent lighting system 300 for multiple parking spaces in a parking garage, though the lights could be used in alternative embodiments for lighting other large areas. Lights of system 300 are arranged in a desired configuration and quantity to light areas of interest. For example, the lights may be arranged in an array of a desired number of rows (denoted by Y=1 to Y=6) and columns (denoted by X=1 to X=5). The lights illuminate circular areas, denoted by illumination circles 330 and 350. For example, in FIG. 1 light 330 illuminates the three stalls indicated 340. Light 350 illuminates the two stalls indicated 360. Note that there is an overlap of the lights 330 and 350 for the stall which is common to both 340 and 360. This is normal and the logic of the system controls both lights 330 and 350 to respond to activity in the overlapping stall, even though the ultrasonic detector 140 for that stall is cabled 175 to only one of the lights 102, 105. The lights can be organized by row 320 and column 310, as shown. Such a configuration accommodate straight forward addressing used by a lighting system computer 1200, to monitor and control the individual lights. FIG. 3 also shows pedestrian entrances/exits, 370 and 375, and the automobile entry/exit 380.

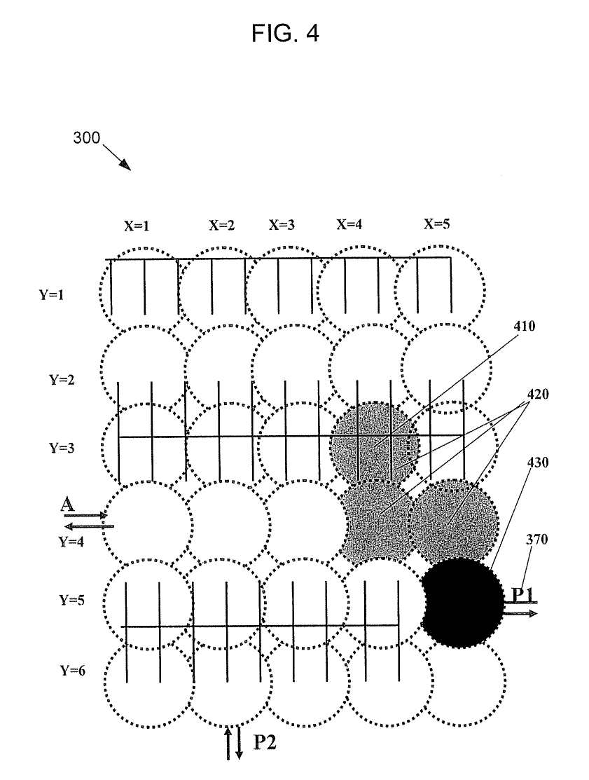

FIG. 4 depicts the intelligent lighting system 300 of FIG. 3 indicating a pedestrian pathway by using different lighting intensities. When, for example, a car has parked at parking space 410, corresponding lights over space 410 can light up. The system 300 can control lights 420 to illuminate a path for the driver to the nearest accessible pedestrian walkway in the area, e.g., indicated by illuminated circuit 430 and pedestrian walkway P1 370.

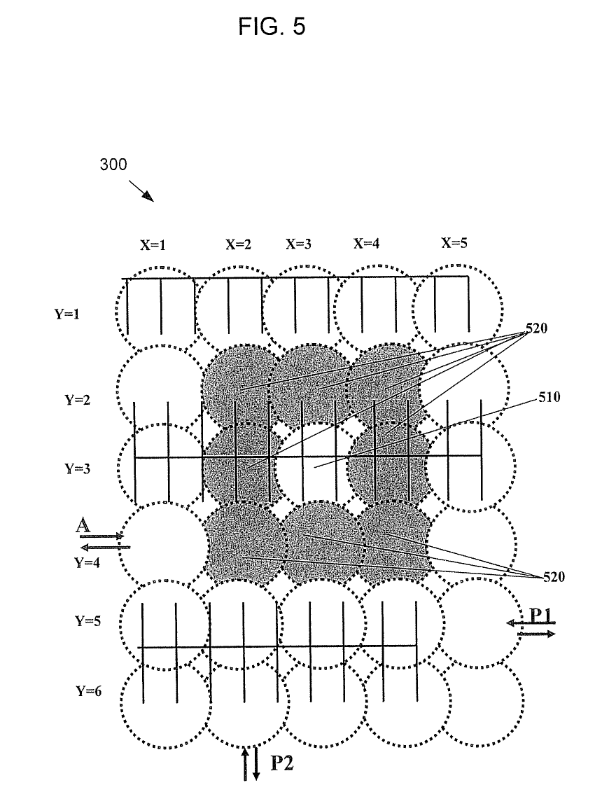

FIG. 5 depicts the intelligent lighting system 300 of FIG. 3 illuminating the way for a pedestrian on the way to or from an automobile. As shown, when a person is detected or known to be at a location of the area, a zone of lighting, as indicated by lighted circles 520 can be turned on to facilitate access to or from a desired location, e.g., a pedestrian at parking space 510. Such a zone can also be used to discourage loitering.

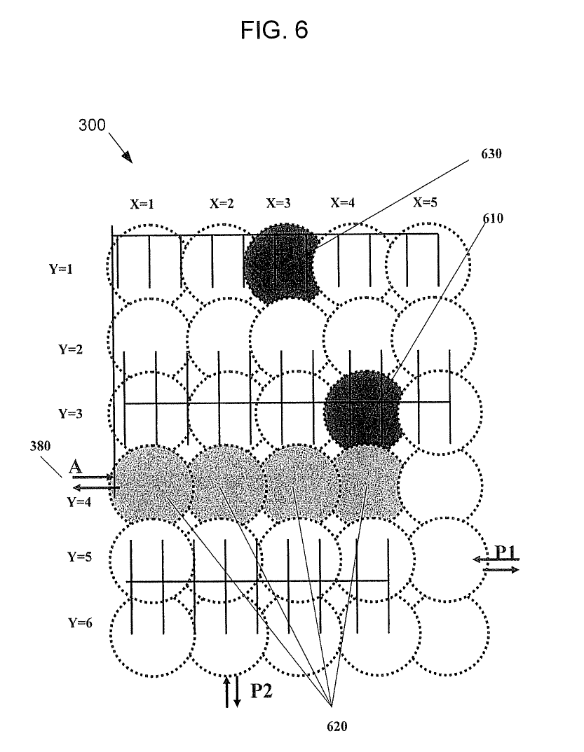

FIG. 6 depicts the intelligent lighting system 300 of FIG. 3 indicating available parking spots by using a particular intensity/color, e.g., shown as circles 610 and 630. The system 300 can use such lighting to indicate to an automobile entering the area, e.g., from A 380, where available spaces are located.

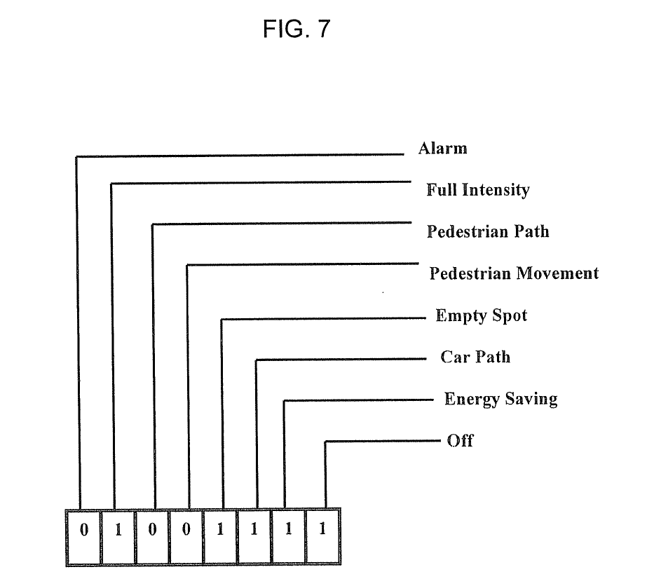

FIG. 7 depicts a priority status byte 700 for a module of an intelligent lighting system, in accordance with exemplary embodiment of the present disclosure. There may be instances when a light in the intelligent lighting system must respond to more than one type of intensity setting. For example, a light may be utilized to show a pedestrian path to an exit, while also showing an empty parking stall. In these instances, the actual setting of the intensity can be predetermined by the priority of all the needed settings, such as shown by the priority byte 700 of FIG. 7.

When the various software routines require that a particular light be in a certain level of intensity, the type of intensity, which will actually be displayed by that light, will be the one with the highest priority. Thus, as FIG. 7 shows, the alarm state would have the highest priority over any other setting for that light. Lower priorities are set as shown, but obviously other versions of the order and number of priority states depends on the stated requirements for any particular user of the intelligent lighting system. When higher priority intensities are not required each individual light defaults to a low energy state, which can be a very low intensity, or even completely off, depending on the preferences of any individual system user.

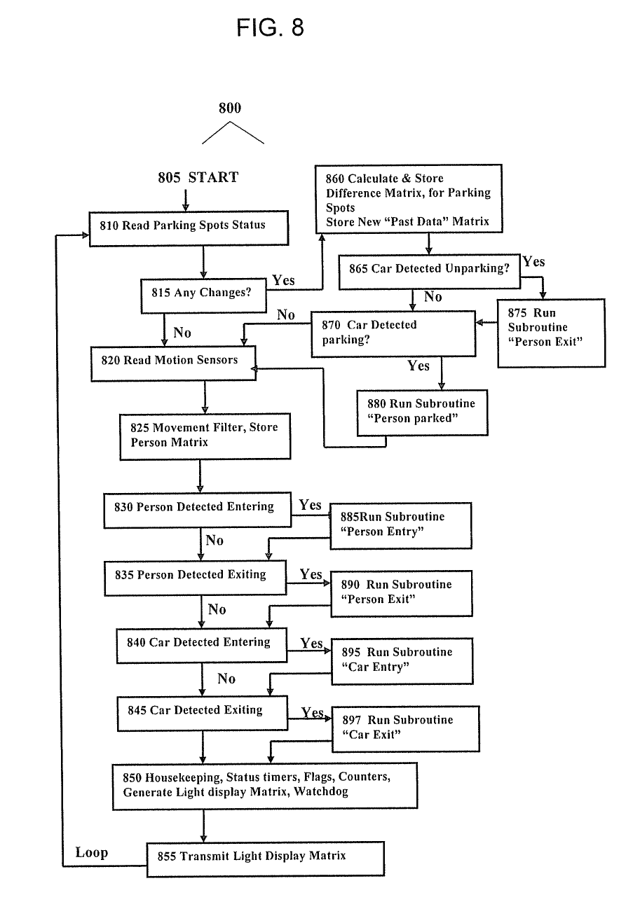

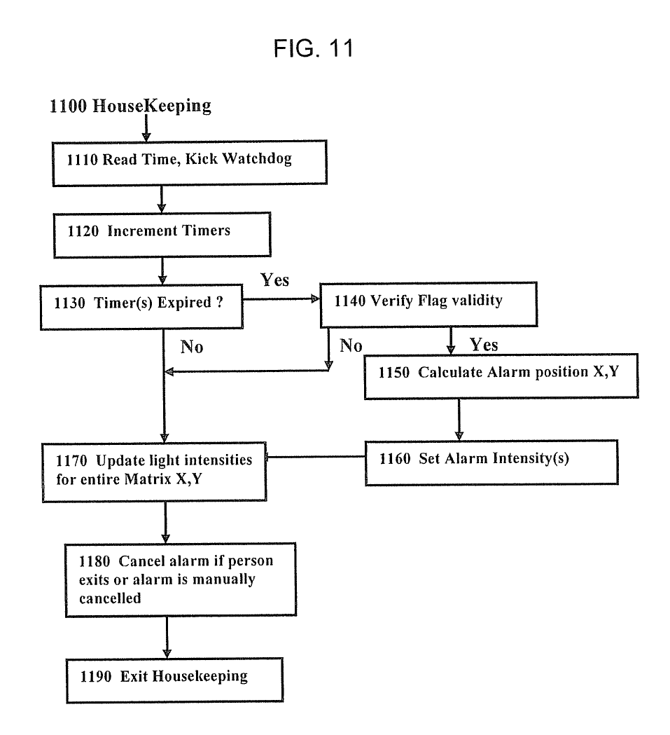

FIG. 8 depicts an overall logic flowchart 800 suitable for intelligent lighting systems, in accordance with an embodiment of the present disclosure. The status of the parking 870 and un-parking 865 of cars, and their arrival or departure from the parking lot 895, 897, 840, 845, and the movements 820, 830, 835, 885, 890,and expected movements 880, of persons are kept in an up to date status by polling method, loop 855 to 810, as shown. The overall summary of this logic can be accomplished by or handled in housekeeping portion 850 (e.g., as later shown and described in detail for FIG. 11) of the loop, which can set the required intensities 855 for each light in the intelligent light system, and transmits this data to these lights. One skilled in the art will appreciate that while the flowchart depicts certain blocks/actions/operations, many variations and alternative software methods can be used to achieve a similar result or results.

With continued reference to FIG. 8, the flowchart can start at 805, and the status or parking spots can be read, as described at 810. A determination of any changes to parking spot status can be made, as described at 815. Motion sensors can be read, as described at 820. In the event changes are indicated for the parking spots status, values for parking spots can calculated and stored, e.g., in a difference matrix (spreadsheet or database) and/or stored as new values, e.g., in a “past data” matrix., as described at 860, A determination can be made as to whether a car is detected unparking (leaving a parking space), as described 865. If a care is detected unparking, a subroutine can be run for a person exiting, as described at 875. A determination can be made as to whether a car is detected parking as described at 870. If a determination is made that a car is detected parking, a subroutine for a person parked can be run, as described at 880. The population values in the matrices indicate multiple persons and cars being processed or tracked simultaneously.

Continuing with the description of flowchart 800, a movement filter can be used, e.g., as described at 825, and a result can be stored in a person matrix. Determinations can be made as to whether a person is detected entering or exiting the area (e.g., garage), as described at 830 and 835, respectively. Likewise, determinations can be made as to whether a car is detected entering or exiting the area, as described at 840 and 845, respectively. When such events are determined to have occurred, corresponding subroutines (controlling reactions of the system or method) can be run, as described at 885, 890, 895, and 897, respectively.

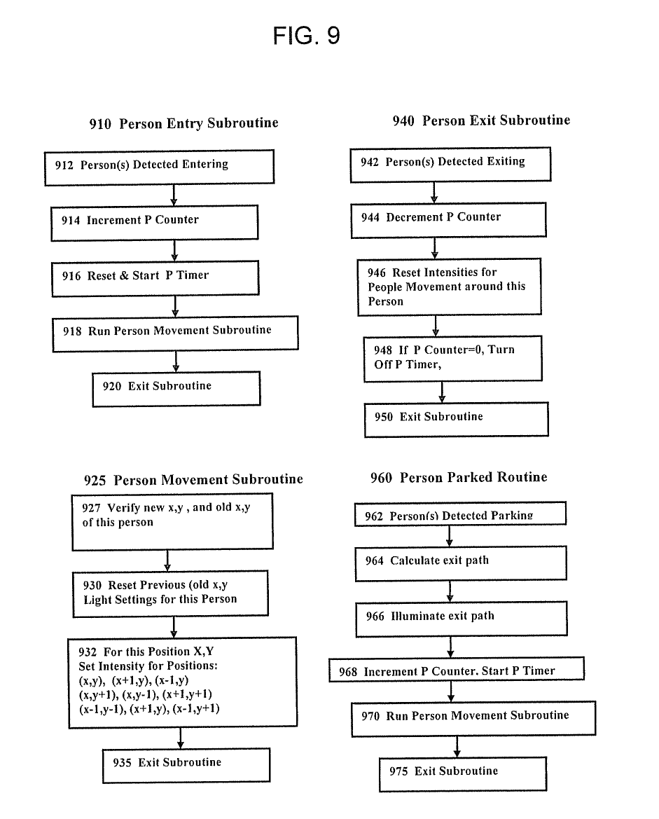

FIG. 9 depicts a logic flowcharts (910, 925, 940, and 960) for subroutines for controlling reactions of an intelligent lighting system or method for various pedestrian scenarios, in accordance with exemplary embodiments of the present disclosure.

A person-entry subroutine 910 can include a number of actions/operations, including a determination as to whether one or more persons have been detected entering the area, as described at 912. A counter (denoted by P, indicating a person) can be incremented, as described at 914. A timer (P timer) can be reset and started, as described at 916. One or more additional optional subroutines can be run, as described at 918, for example a person movement subroutine described subsequently for 925. The subroutine can then be exited, as described at 920.

A person-movement subroutine can include a number of actions/operations, as described at 925. Coordinates (e.g., relative x and y coordinates) can be verified/determined for a person in the area, as described at 927. A reset to previous/desired lighting conditions can be performed (such as for old/previous light settings for the person), as described at 930. A new or updated light intensity or color can be set for adjacent positions in the area, as described at 932. For example, intensities can be set for lights around the identified position (x,y) in a pattern: (x,y), (x+1,y), (x−1, y), (x, y+1), (x, y−1), (x+1, y+1), (x−1, y−1), (x+1, y−1), (x−1, y+1). The subroutine can then be exited, as described at 935.

A person-exit subroutine 940 can include a number of actions/operations and/or corresponding commands, including a determination as to whether one or more persons have been detected exiting the area, as described at 942. A counter (denoted by P) can be decremented, as described at 944. Appropriate lighting intensities (e.g., ones for “people movement) can be set around the person, as described at 946. If the P counter equals zero, the person/people timer (P timer) can be reset or turned off, as described at 916. The subroutine can then be exited, as described at 950.

A person-parked routine 960 can include one or more actions/operations, including a determination of one or more persons detected parking, as described at 962. An exit or egress path can be calculated for the one or more persons, as described at 964.

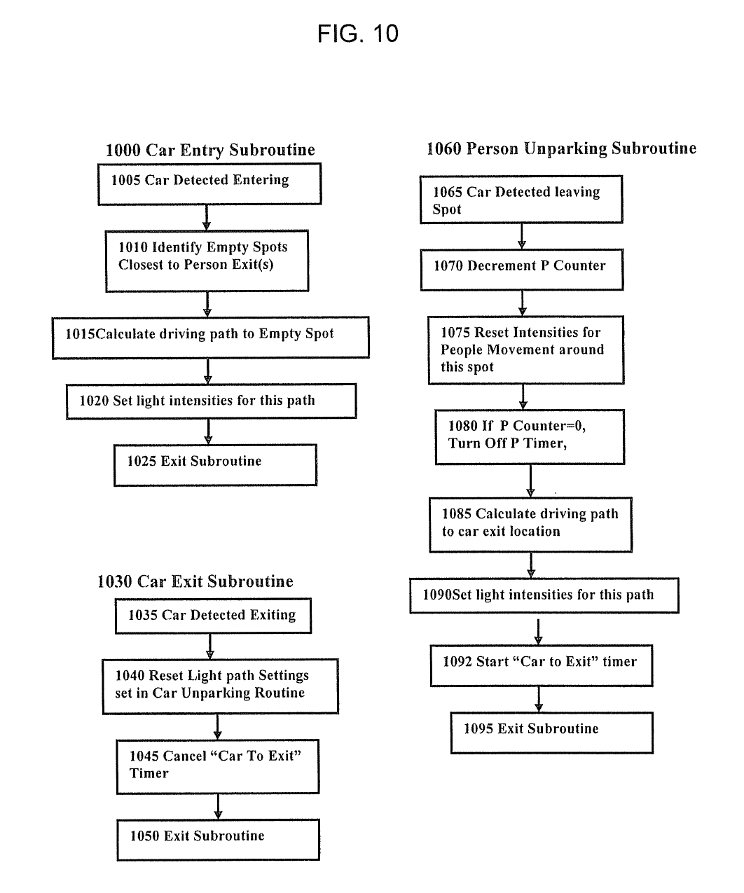

FIG. 10 depicts logic flowcharts (1000, 1030, 1060) for reactions of an intelligent lighting system or method for various automobile entry and exit scenarios, in accordance with exemplary embodiments of the present disclosure.

A car-entry subroutine 1000 can include multiple actions/operations and/or corresponding commands, including a determination as to whether a car is detected entering an area, as described at 1005. One or more empty spots can be identified that are closest to one or more person or pedestrian exits, as described at 1010. A driving path to the closest empty spot can be calculated/determined, as described at 1015. Light intensities can be set/specified for the path, as described at 1020. The subroutine can be exited, as described at 1025.

A car-exit subroutine 1030 can include multiple actions/operations and/or corresponding commands, including a determination as to whether a car is detected exiting an area, as described at 1035. Light path settings can be reset in a car-unparking subroutine, as described at 1040. A car-to-exit timer can be cancelled or turned off, as described at 1045. The subroutine can be exited, as described at 1050.

A person unparking subroutine can include multiple actions/operations and/or corresponding commands, including a determination as to whether a car is detected leaving a parking spot/space/stall, as described at 1065. A counter (e.g., P counter) can be decremented, as described at 1070. Intensities can be reset for people movement around the parking spot, as described at 1075. If the counter value equals zero, the counter can be turned off, as described at 1080. A driving path to a car/automobile exit location can be calculated/determined, as described at 1085. Lighting intensities can be set for the path, as described at 1090. A car-to-exit timer can be started, as described at 1092. The subroutine can be exited, as described at 1095.

FIG. 11 shows the logic flowchart 1100 for internal housekeeping activities, of an intelligent lighting system/method in accordance with embodiments of the present disclosure. FIG. 11 shows a typical logic flow diagram for the housekeeping portion of the intelligent lighting.

The portion of software (modules and/or instructions) of flowchart 1100 can be used to insure that an intelligent lighting system/method is running by kicking a watchdog and reading the elapsed time 1110. The time can be used to check whether there is a person taking too long 1130, 1140, to complete his expected activity. The timers and flags can be set, e.g., in 916 and 968 of FIG. 9, when a person starts first enters the horizon event of the system, by either parking his car 962 or entering at the entrance 912. If the person(s) move according to expectations, they should either un-park their car (e.g., as described in 1065 of FIG. 10), or exit the area (e.g., as described at 942 of FIG. 9). The action of the person(s) thus leaving can cancel the appropriate flags and timers (e.g., at 948 of FIG. 9, and 1080 of FIG. 10), and no further action is required by the intelligent lighting system for these person(s). Should the person(s) take too long to exit (e.g., loiter within the garage, or move about without exiting), however, then the timer expires, and an alarm can be initiated, which flashes the lighting at the position of the loitering person 1150, 1160. All the required lighting intensities can be updated for the current loop of the software execution, as described at 1170. The alarm can be cancelled when the alarm condition is no longer valid, or cancelled by an operator, as described at 1180. Similarly, if a car un-parks and does not exit, an alarm condition is detected (e.g., at 1092 of FIG. 10). The housekeeping routine can then be exited, as described at 1190.

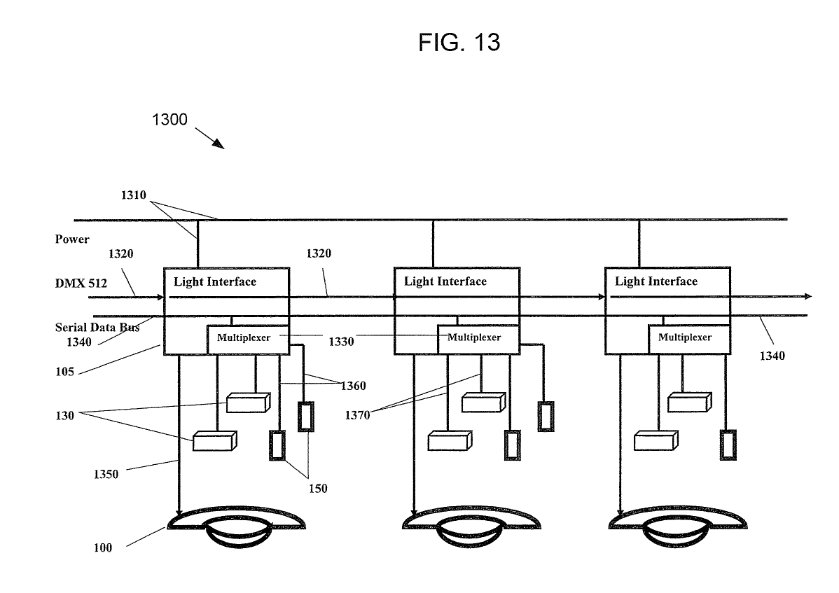

FIGS. 12 and 13 shows a typical method of interconnecting the individual lights of the intelligent lighting system. In FIG. 12, the same parking garage layout for system 300 (previously described) is shown, with the lights in matrix array x=1 to 5 and y=1 to 6, serviced by cable bus 1240. The cable bus source includes the power for the system 1210 connected by power cable 1230. The data to and from the intelligent lighting system computer 1200, is via the cables 1220. Sensory data concerning the entrances and exits for persons and cars 1260 from commercially available access control systems, is made available to the computer 1200 by cables 1250. The intelligent lighting system computer 1200 can be a commercially available unit, in exemplary embodiments; a hardware interfaces can be commercial items, e.g., that can function with/for the DMX 512 signals and/or serial data bus signals, where “DMX” refers to the Entertainment Technology—IJSITT DMX512-A—Asynchronous Serial Digital Data Transmission Standard for Controlling Lighting Equipment and Accessories. The software can be specifically designed for the intelligent light features as previously outlined, but the configurations and specific preferences of intensity settings, intensity priorities, and alarm handling are customized to the end user's specifications.

FIG. 13 shows the detail of the individual lights in an intelligent lighting system 1300 in accordance with an exemplary embodiment of the present disclosure. The cable buses 1310, 1320, and 1340 can be components and detailed parts of the cable bus 1240. The cable bus 1240 can consist of the power lines 1310, suitable signals, e.g., DMX 512 signals 1320, and serial bus lines 1340. The cable run can be terminated (i.e., connected) in each light interface 105. The serial data from bus 1340 can be used by the multiplexer 1330 unit in the interface to poll the ultrasonic distance detectors 130 and motion sensors 150 through their respective cables 1370 and 1360. The data thus collected is reported back to the central system lighting computer 1200 by the serial bus 1340. The data (e.g., DMX 512 data) from lines 1320 set the required intensity of the light 102, using power from the power lines 1310 and directed to the lighting elements by cable 1350. Both intensity and color can be controlled by this data. By repeating this setup at each individual light of the intelligent lighting system, the lighting system computer 1200 can monitor the lighting requirements for the entire parking garage and maintain the lowest energy budget while providing additional safety features.

In exemplary embodiments of the present disclosure, the acoustic sensors can all be located in a single housing. This configuration may be desirable and/or necessary when the parking spaces to be monitored are outdoors, so there is no convenient ceiling mount above each individual parking spot. This single housing can be located at or nearby the light fixture housing, on the same physical post, or even within the lamp housing itself. This configuration has the additional advantage of not requiring a cable run to each of the acoustic sensors. Each acoustic sensor in the housing is activated one at a time, to prevent interference between units, i.e. time multiplexed. Other embodiments can employ wireless communication (e.g., infrared or RF transmission) of data/signals from point to point, rather than through wiring or cables (e.g., copper or optical).

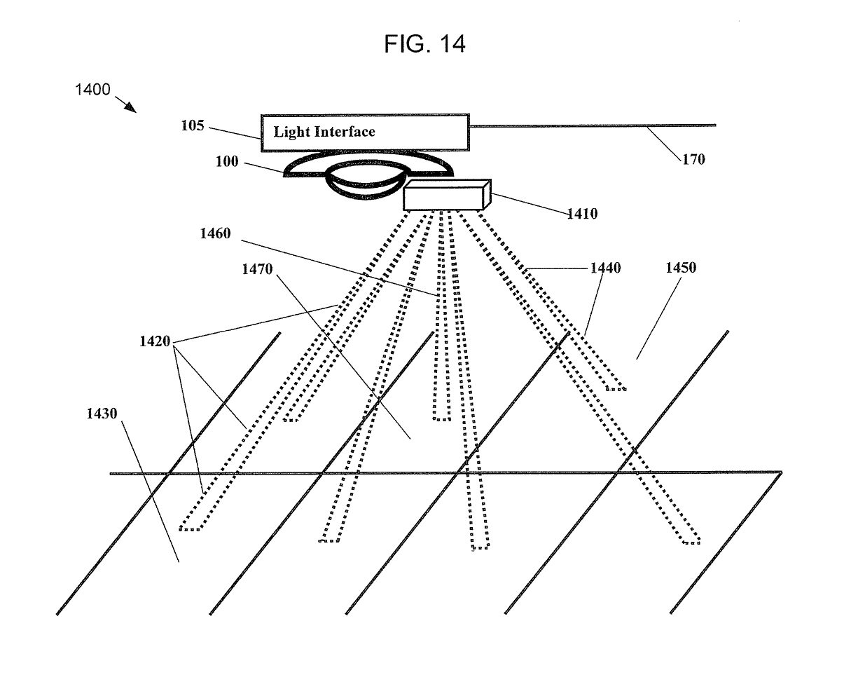

FIG. 14 depicts a portion of an intelligent lighting system 1400 in which multiple acoustic sensors are located in a single housing, in accordance with an embodiment of the present disclosure. FIG. 14 shows the housing for the acoustic sensors, item 1410, attached nearby to the light fixture, item 102. The acoustic beams can arranged at any angle, from vertical (item 1460), to other rotations, such as 1420 and 1440. This allows beam 1420 to monitor space 1430, while beam 1440 monitors space 1450, even though the housing is located directly above space 1470, which is monitored by vertical beam 1460. The beams are angled the required amount and fixed in place when the system is installed, by simply pointing each sensor to the center of the parking spot to be monitored.

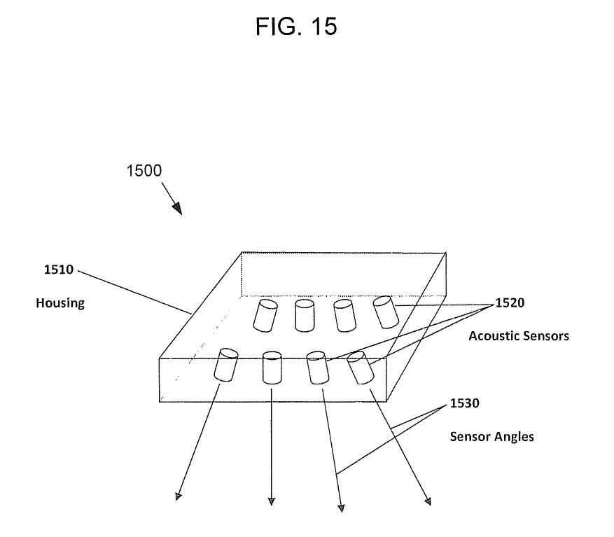

FIG. 15 depicts an embodiment of a acoustic sensor subsystem 1500 in which multiple acoustic sensors are configured in the same housing, with each set to monitor different parking spots in accordance with an embodiment of the present disclosure. FIG. 15 shows how the multiple acoustic sensors (items 1520) have been located into single housing, item 1510. Each of the sensors 1520 can be adjusted to various angles, as shown by the beam angles item 1530. The sensors can be rotated in two degrees of freedom, to allow each sensor to be pointed to any parking spot under the light fixture. The acoustic sensors can be fixed at the desired angle by a mechanical tightening assembly.

### Information and Safety

As mentioned previously, intelligent lighting techniques of the present disclosure can provide not only illumination for the user, but also several types of information and safety features. For example FIGS. 6, 10 and 12 shows how the system reacts to the arrival and parking of an automobile in one of it's monitored stalls. For example, as shown in FIG. 12, the lifting of the entrance gate 1260 (commercially available) sends a trigger pulse via cable 1250 to the lighting system computer 1200, which in turn causes, in FIG. 10, subroutine 1000, for the car entry, to be activated. (This is accomplished by the lighting system computer's 1200 main software logic, 800 FIG. 8, which will be further described later). Continuing on FIG. 10, the car detected entering 1005, causes the system to determine the nearest available parking stall by software step 1010. The computer then looks up the best route to that stall, step 1015, and lights the way. This is shown in FIG. 6, where the car entry point 380, has the shortest route 620 illuminated at a specific guidance intensity (and possibly color) level, into the nearest empty available stall 610, indicated by a different but noticeable intensity (and possibly color) of the lights at location 610. Alternative empty stalls nearby 630, are also similarly illuminated, thus giving the driver a choice of available empty stalls.

In a like manner, when a car is detected leaving a parking stall, the path to the car exit is specially illuminated. When the driver has parked his vehicle in an empty stall, the ultrasonic distance detector at that stall will indicate this to its intelligent light unit. For example, as shown in FIG. 4, a driver has just parked into the previously empty but now occupied stall 410. The intelligent light system activates the person parked subroutine (e.g., subroutine 880 in FIG. 8, which calls up software subroutine 960 in FIG. 9). When a car is freshly parked, person(s) are expected to exit the vehicle, and head towards the exit, as shown in subroutine 960 in FIG. 9. The relevant intelligent light unit reports to the lighting system computer 1200 at step 962. The lighting system computer 1200 looks up the best path to the nearest exit, 964. The lighting system computer 1200 then sets the lights along this path to the appropriate illumination and color setting 966. These instructions from the lighting system computer 1200, are reflected in FIG. 4, where it is shown the freshly parked stall 410, the nearest exit 370, the illuminated path 420, and the special intensity to mark the exit 430.

The subroutine 960 then continues by incrementing the P counter 968, which indicates the number of groups of persons in the garage, and also starts the P (persons in transit) timer. This timer sets a maximum time between the parking of the vehicle, and the exit of persons from the garage area. It detects if a person parks a car, then loiters in the parking area for too long a time. It is a safety feature, and can be handled in the housekeeping software (e.g., as shown and described for FIG. 11). Subroutine 960 then initiates the person in movement subroutine 970. This subroutine maintains a level of light intensity around a person(s) walking through the garage. This is illustrated in FIG. 5, where a person(s) detected at 510 causes all the adjacent lights 520 to maintain a comfortable, safe lighting level some distance from the person(s). As the person moves through the garage, this appropriate lighting level effectively follows him, as shown in subroutine 925, the person movement subroutine. Thus if a person chooses not to go along the path calculated to the nearest exit, his way will still be illuminated in a safe manner.

Accordingly, embodiments of the present disclosure can provide one or more advantages over previously existing lighting techniques for large areas, such as parking garages, warehouses, and the like.

While certain embodiments and/or aspects have been described herein, it will be understood by one skilled in the art that the methods, systems, and apparatus of the present disclosure may be embodied in other specific forms without departing from the spirit thereof. For example, while exemplary embodiments have been described in the context of utilizing ultrasonic sensors to detect occupancy data for parking spaces, other sensors can be used in conjunction with or alternative to ultrasonic sensors, within the scope of the present disclosure. One skilled in the art will appreciate that the techniques of the present disclosure can be utilized for the intelligent lighting of many areas/structures, including but not limited to warehouses and the like, not solely those used for parking automobiles. Moreover, while lighting techniques herein have been described in the context of a particular protocol, DMX512-A, such techniques can be used with other communication protocols. Also, one skilled in the art will appreciate that while the flowchart described herein depict certain blocks/actions/operations, variations and alternative software methods can be used to achieve a similar result or results. Accordingly, the embodiments described herein, and as claimed in the attached claims, are to be considered in all respects as illustrative of the present disclosure and not restrictive.

What is claimed is:

1. An intelligent lighting system for a parking garage, the system comprising:
a plurality of lighting elements configured and arranged to illuminate one or more parking stalls in a parking garage;
a plurality of ultrasonic acoustic sensors configured and arranged to obtain occupancy data of the one or more parking stalls; and
a controller that is configured and arrange to use data from the ultrasonic sensors to control optical output of the lighting elements.

2. The system of claim 1, further comprising one or more additional sensors configured and arranged to obtain occupancy data of the parking stalls.

3. The system of claim 1, wherein the additional sensors comprise one or more video cameras, one or more electronic loops under the ground, or one or more infrared sensors.

4. The system of claim 1, wherein the controller is configured and arranged to cause a warning to be issued.

5. The system of claim 1, wherein the controller is configured and arranged to cause the plurality of lights to show a path to an exit for pedestrians.

6. The system of claim 1, wherein the controller is configured and arranged to cause the plurality of lights to show an automobiles entering the garage the available parking stalls by variation of the light intensities and/or color.

7. The system of claim 1, wherein the controller is configured and arranged to cause the plurality of lights to show an to show indicate a path by variation of the light intensities and/or color.

8. The system of claim 1, wherein the controller is configured and arranged to receive or transmit data by wireless communication.

9. The system of claim 1, wherein each of the plurality of acoustic sensors is placed above a respective parking stall.

10. The system of claim 1, wherein the plurality of acoustic sensors are located within a single housing.

11. A method of lighting a parking garage, the method comprising:
illuminating a plurality of more parking stalls in a parking garage with a plurality of lighting elements;
obtaining occupancy data of the parking stalls by using a plurality of ultrasonic distance measuring sensors; and
using the occupancy data for control of the light intensities and/or color of the individual lighting elements.

12. The method of claim 11, further comprising using video cameras, electronic loops under the ground, or infrared sensors for obtaining occupancy data.

13. The method of claim 11, wherein the occupancy data of the parking spots is augmented by passive infrared sensors to also obtain data on persons within the garage.

14. The method of claim 11, further comprising warning of persons behaving in an unexpected pattern by variation of light intensities and/or color.

15. The method of claim 11, further comprising setting an intensity and/or color of one or more lights to show a path to an exit for pedestrians.

16. The method of claim 11, further comprising indicating for automobiles entering the garage available parking stalls by variation of the light intensities and/or color or one or more lights.

17. The method of claim 1 1, further comprising setting the intensity and/or color of one or more lights to show a path to an exit for an automobile.

18. The method of claim 11, further comprising changing intensity and/or color of lights person immediately surrounding a person moving through the garage.

19. The method of claim 11, wherein the various levels of intensity and/or color designating various operational states are assigned various preset values with a priority status.

20. The method of claim 19, wherein the preset intensity levels include variations in the color of the light emitted.

21. The method of claim 11, wherein the acoustic sensors are placed above each parking spot to be monitored.

22. The method of claim 11, wherein the acoustic sensors are located within a single housing.

23. An intelligent lighting system for a large person-accessible area, the system comprising:
a plurality of lighting elements configured and arranged to illuminate one or more subareas of the area;
a plurality of ultrasonic distance measuring sensors configured and arranged to obtain occupancy data of the subareas; and
mean for controlling the lighting elements, wherein the means for controlling is configured and arranged to use the occupancy data to control the light intensities and/or color of the individual lights in the system.

24. The system of claim 23, further comprising additional occupancy sensors.

25. The system of claim 24, wherein the additional occupancy sensors comprise infrared sensors configured and arranged to obtain data on persons within the area.

26. The system of claim 25, wherein the infrared sensors include passive infrared sensors.

27. The system of claim 25, wherein the infrared sensors include active infrared sensors.

28. The system of claim 23, further comprising a DMX512-A data bus.

29. The system of claim 23, wherein the plurality of lighting elements includes one or more halogen lights.

30. The system of claim 23, wherein the plurality of lighting elements includes one or more LEDs.
